(19) United States
(12) Patent Application Publication
(10) Pub. No.: US 2011/0220243 A1
(43) Pub. Date: Sep. 15, 2011

(54) MOBILE LIQUID WASTE LOADING SYSTEM

(75) Inventor: Nicholas James Szabo, Cambridge (CA)

(73) Assignee: FERTHAUL CANADA INC., Cambridge (CA)

(21) Appl. No.: 12/876,529

(22) Filed: Sep. 7, 2010

(30) Foreign Application Priority Data
Mar. 15, 2010 (CA) 2696915

(51) Int. Cl. B67D 7/78

(52) U.S. Cl. 141/266

(57) ABSTRACT

A mobile system for use in transfer of liquid waste reduces loading and/or unloading times required during transfer to a tank truck or transfer from a tank truck to other equipment such as spreading equipment. The system includes a transfer tank that is raised and lowered to provide improved transfer due to gravity assist. The tank is provided on a structural frame that includes a lifting arrangement for supporting the tank at least six feet above a ground position. Preferably the structural frame is part of a trailer to allow convenient transport. The system has particular application for liquid manure transfer systems.

### FIELD OF THE INVENTION

The present invention relates to mobile liquid loading systems and in particular relates to mobile loading systems for transfer of liquid waste such as liquid manure waste or liquid biosolid waste to or from a vehicle storage tank.

### BACKGROUND OF THE INVENTION

It is well recognized that animal manure is a valuable source of fertilizer, and it is typically temporarily stored for subsequent field application. In many modern farm applications manure is transferred from the barns to a holding lagoon and eventually is loaded in tanker trucks and transported a short distance for subsequent field application. Loaded tanker trucks are typically unloaded to a dedicated spreading device which then applies it to the field.

It is known to use tanker trucks having vacuum tanks thereon to reduce the time required to transfer the liquid manure from the lagoon to the tanker truck. Pumps may also be used to reduce loading time. In some cases high volume pumps are used to rapidly fill a tanker truck but do not have a high utilization rate. Vacuum tanker trucks are quite specialized and relatively expensive to purchase, and similarly high capacity pumps are costly and can introduce other filling problems.

For many reasons, it is more common to use top load tanker trucks typically with an 8,000-12,000 gallon tank. These tanker trucks are often purchased used, and do not require the high investment cost of specialized vacuum trucks. Typically these tanker trucks are relatively small as the roads are typically secondary roads and off loading may require some limited access to fields adjacent these roads.

Loading times with a vacuum-type truck may be in the range of 8 to 10 minutes, as opposed to a top load truck where the load time may be in the order of 15 minutes. It is possible to provide additional pumps to reduce the loading time, however more rapid loading often produces foam within the tank and reduced ability to transfer full loads.

A significant factor with liquid manure transfer systems or other transfer systems is the restricted time period where it is desirable to apply the manure to the fields. Typically in a given year this time period may be 180 days or less. Weather is a significant factor, however the particular crop and stage of the crop must also be considered.

It would be desirable to provide a system that is cost effective to produce and provides flexibility with respect to varying the system for different job requirements.

### SUMMARY OF THE INVENTION

A mobile loading system according to the present invention is typically used in transfer of liquid waste. The system comprises a structural frame and at least a pair of wheels mounted to the structural frame, a transfer tank mounted above the structural frame with the supply tank including a bottom outlet sized for high flow gravity unloading of the supply tank. The structural frame includes a lifting and support arrangement movable between a storage position with the wheels generally adjacent to the ground to a raised operating position at least six feet above the position of the structural frame in the storage position.

In a preferred aspect of the invention, the lifting and support arrangement includes at least 3 vertically extendible lifting members, and the lifting members are laterally movable from the storage position adjacent the structural frame outwardly to the operating position. The lifting members are extendible to engage a ground support surface and subsequently raise the structural frame to the operating position.

In a further aspect of the invention, the lifting and support arrangement includes 4 vertically extendible lifting members positioned in pairs at opposite ends of the supply tank. Preferably, the 4 vertically extendible lifting members are hydraulic cylinders.

In a modified system of the present invention the supply tank is a vacuum tank.

In an aspect of the modified system the vacuum tank includes a loading arm connected to the vacuum tank adjacent a bottom level of the vacuum tank. The loading arm includes an on/off control valve for controlling discharge through the loading arm.

In a preferred aspect of the modified system the lifting arrangement includes a drive arrangement for quickly raising the structural frame from a ground position for loading of the vacuum tank to the raised operating position for gravity assisted unloading of the vacuum tank. This system is advantageous for gravity assisted transfer from a tank truck to the vacuum tanks (storage position) in combination with gravity assisted transfer from the vacuum tanks to other equipment (raised position) such as spreading equipment.

### BRIEF DESCRIPTION OF THE DRAWINGS

Preferred embodiments of the invention are shown in the drawings, wherein:

FIG. 1 is a perspective view of the mobile loading system and an associate tanker truck;

FIG. 2 is a schematic type view showing the mobile loading system, the top loading tanker truck and a holding lagoon;

FIG. 3 is a schematic similar to FIG. 1 showing the return overflow associated with the supply lagoon;

FIG. 4 is a side view of the mobile loading system in a transport position;

FIG. 5 is a schematic of the mobile loading system in a raised operating position for loading of the tanker truck;

FIG. 6 illustrates an alternate arrangement of the mobile loading system that is used to transfer the manure from the tanker truck to the mobile loading system and subsequently to the spreading equipment;

FIG. 7 is a perspective view of the alternative system showing it loading a spreading apparatus;

FIG. 8 is a side view of the alternative arrangement in a transport position;

FIG. 9 is a view similar to FIG. 8 with the alternative system about to be used for transfer;

FIG. 10 is a view similar to FIG. 9 with the alternative system in a raised farm equipment loading position; and

FIG. 11 is a view similar to FIG. 10 with the alternative position and the raised loading position for loading of farm equipment.

### DETAILED DESCRIPTION OF THE PREFERRED EMBODIMENTS

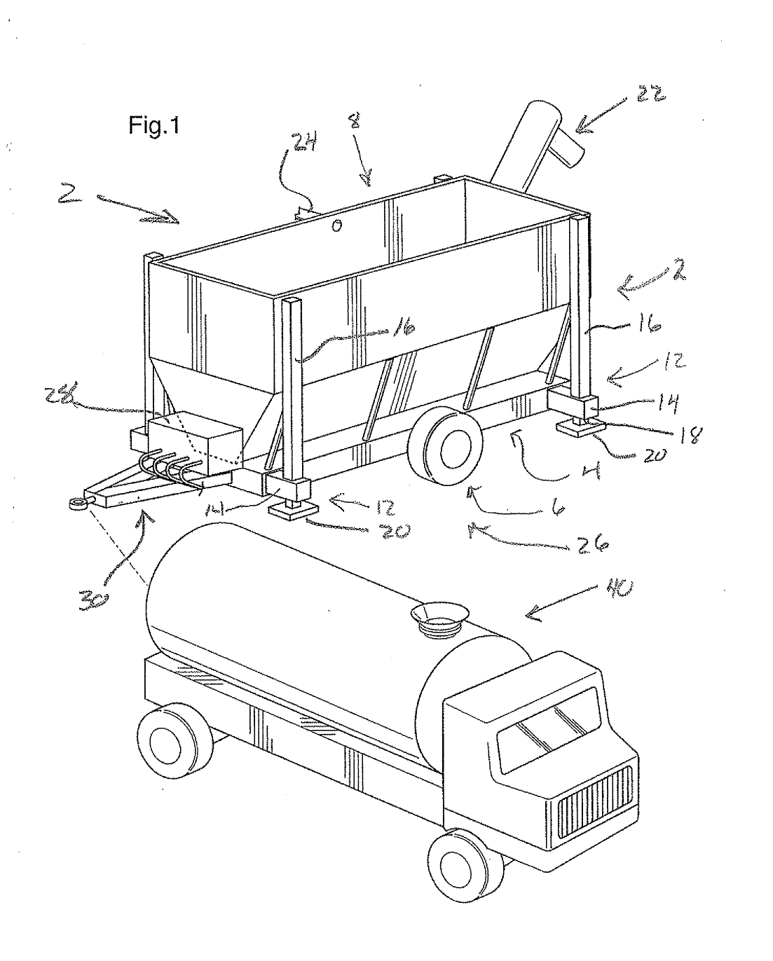

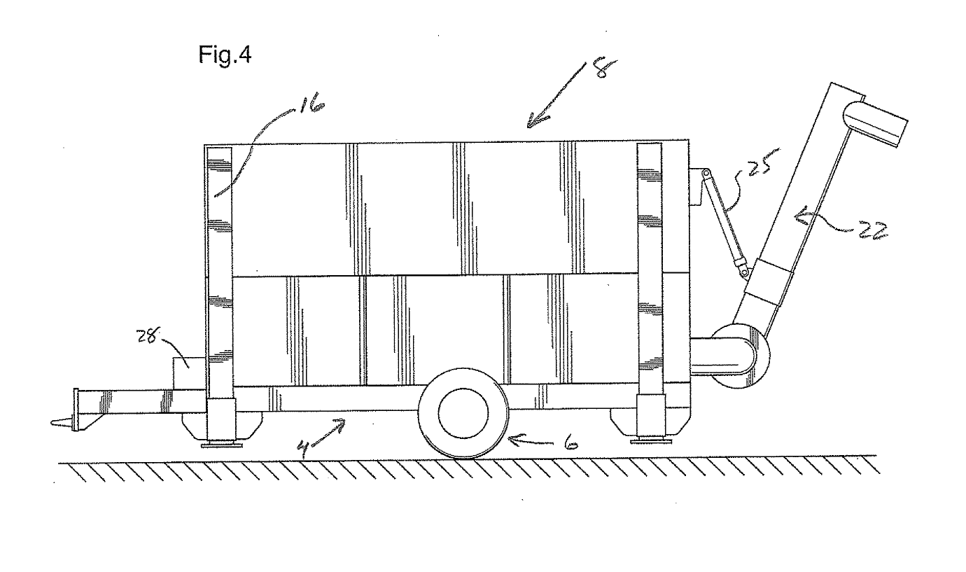

The mobile loading system 2 shown in FIGS. 1 through 5 is used for loading of tanker trucks, tanker trailers or liquid manure spreading equipment from a holding lagoon or other supply source. As can be appreciated the loading system can be effectively used to load different types of transport systems, and is not limited to tanker trucks, however these may be the most common transfer vehicle.

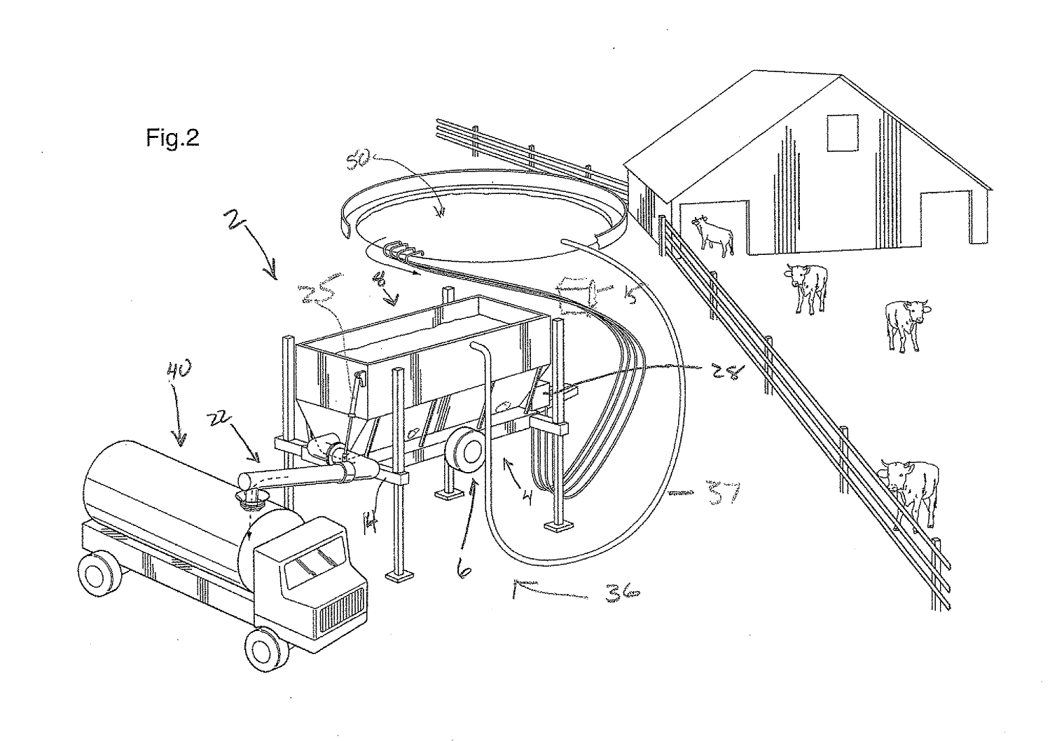

The system includes a structural frame 4 having a series of wheels 6 to allow transport of the system on highways and roads as well as on site locations. The mobile system is essentially a trailer with a retractable lifting and support arrangement generally shown as 12. FIGS. 1 and 2 show details of the mobile loading system 2 and in particular the ability of the structural frame 4 via the lifting and support arrangement 12 to be moved from a transport type position as shown in FIG. 1, to a raised operating position (8 to 12 feet above ground) as shown in FIG. 2. The structural frame 4 includes the transfer tank 8 that receives the liquid manure or other liquid waste. The transfer tank preferably has an open top to reduce foam accumulation and a “V” bottom to assist in removal of sand and solids.

The liquid manure is pumped from a lagoon such as 50 or other holding facility via pumps 15 and the liquid manure is fed through bottom inlets into the transfer tank 8. Typically the pumps 15 are of a relatively low horsepower and have a capacity to fill the transfer tank 8 in a particular period of time. For example, if trucks are anticipated to be returning to the mobile system on an approximate 20 minute time period, the pumps are operated to generally load the transfer tank during this time period. Additional pumps can be used to ensure that the fill rate is sufficient to correspond with the anticipated times that tanker trucks will be returning.

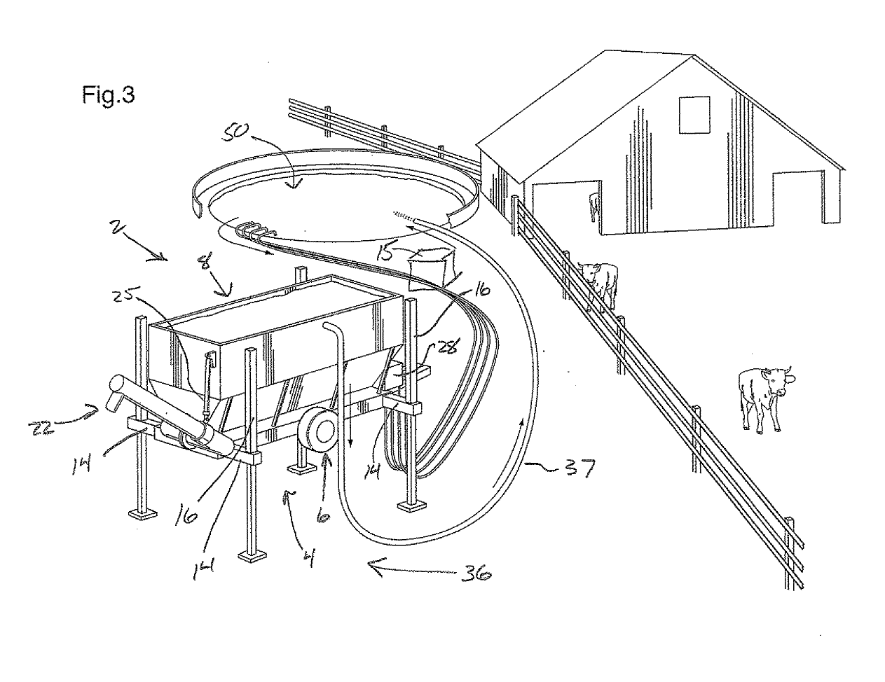

Preferably, the pumps 15 run continuously and in the preferred embodiment as shown in FIGS. 2 and 3, the transfer tank includes a return line 37 which effectively acts as an overflow. The tank as shown in FIG. 1 does include the overflow port 24. This provides a convenient system that allows the pumps 15 to run continuously for filling of the transfer tank. If a delay occurs before a tanker truck returns, there is no danger of a spill as the liquid manure is returned through the overflow outlet. As can be appreciated, it would also be possible to use a sensor associated with a filled condition of the tank to turn off the pumps. It is generally preferable to have the pumps continuously run to maintain some circulation within the tank to avoid settlement and it also just provides a simpler solution.

Typically the liquid manure is pumped into the bottom of the tank through one or more bottom inlets 52 and these inlets are positioned to provide circulation within the tank.

During the initial setup the transfer tank 8 is raised to a position preferably above the height of the tanker truck 40. This allows a loading boom 22 to be inserted in the tanker truck and an on/off valve associated with the loading arm 22 will allow rapid gravity bottom filling of the tanker truck. With this arrangement the loading time of the transfer truck can be reduced from approximately 10-15 minutes (conventional non vacuum equipment) to 2-4 minutes. This provides a large cost saving as the operator and the tanker truck represent an hourly rate of approximately $80.00 an hour.

The mobile loading system 2 uses the lifting and support arrangement 12 to elevate and support for transfer tank 8. This lifting and support arrangement includes laterally extendable beams 14 that telescope within structural members of the structural frame 4. The beams 14 allow the hydraulic cylinders 16 to move outwardly and thereby increase the base of the support arrangement and the stability thereof. The hydraulic cylinders 16 include the movable piston rams 18 having ground engaging feet members 20 provided at the ends thereof. It may be necessary depending on the particular location to provide additional support pads for the elevating cylinders.

Before the tank is loaded it is brought into position and then raised to the operating position of

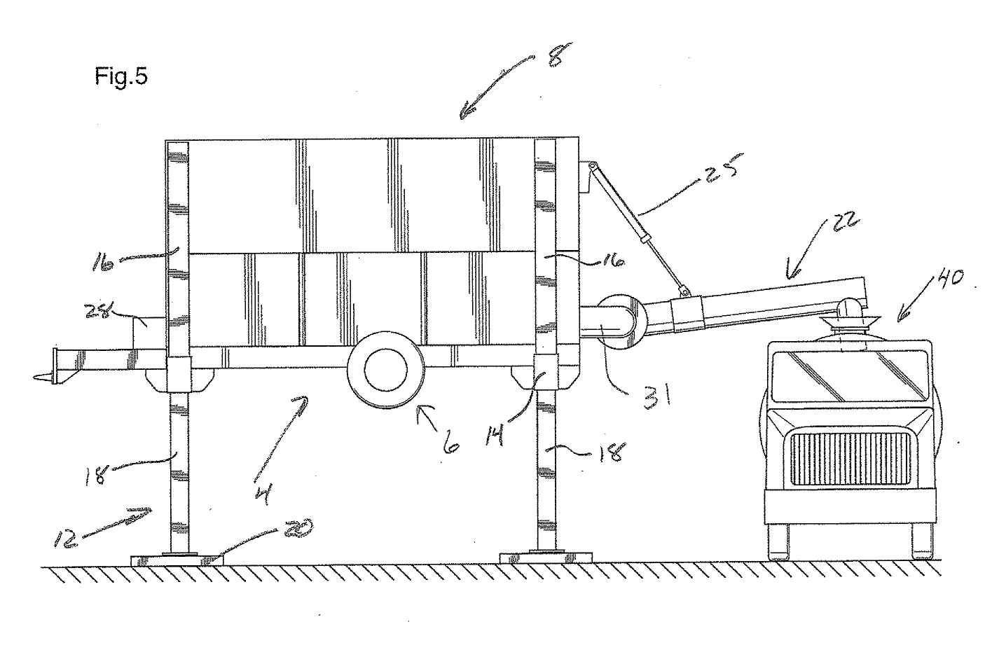

FIG. 2. The initial transport position is generally shown in FIG. 1. A hydraulic power source 28 is shown for powering of the hydraulic cylinders. In this embodiment this power source is primarily used during the initial set up, and the hydraulic cylinders are then effectively locked (hydraulically) to maintain the cylinders in their extended position. The loading arm 22 includes a hydraulic cylinder shown as 25 for returning the arm to the upright position. Cylinder 25 allows the arm to be lowered for loading of the trucks and returns the arm to the raised position shown in FIG. 1 and in other drawings as required. As shown in the side view of FIG. 5, the mobile loading system includes a large discharge outlet 31 at one end of the transfer tank 8 and this provides for rapid gravity loading of the tanker truck. Typically there is a knife-type valve associated with the loading arm to provide control and a fast shut off of the arm.

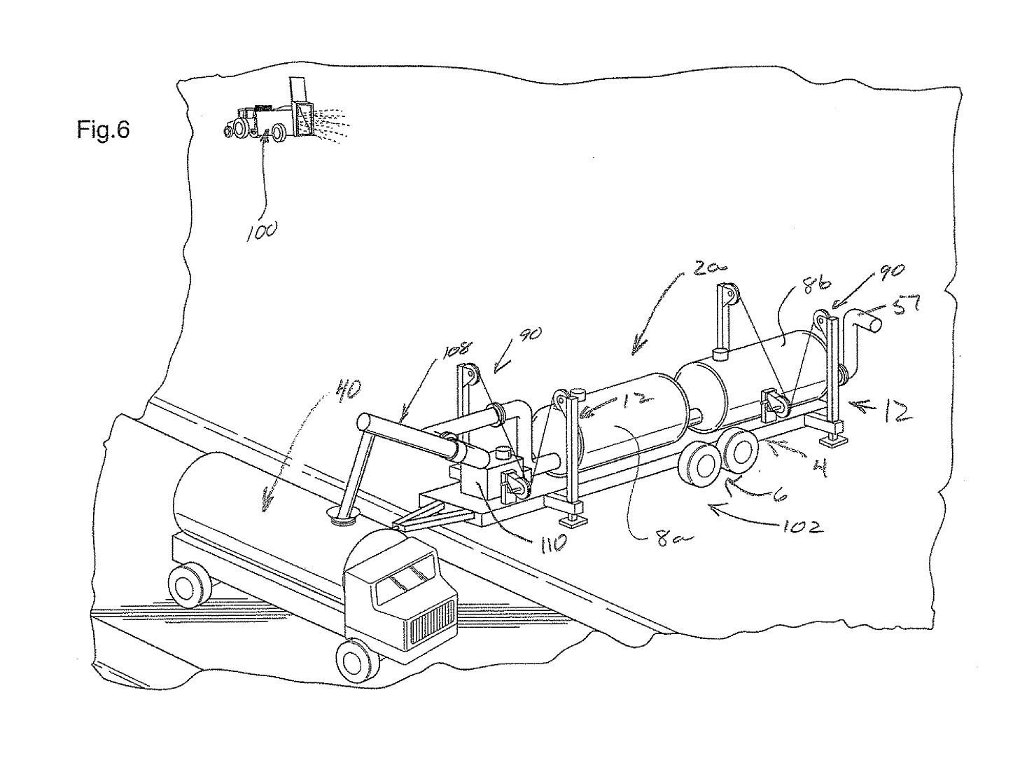

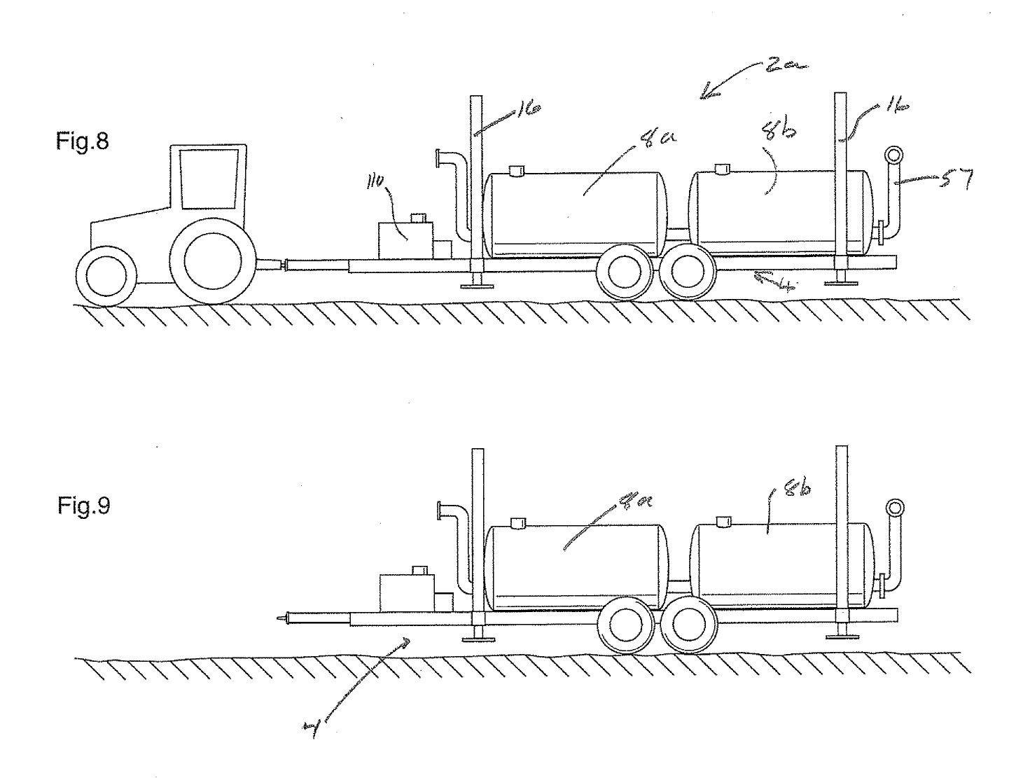

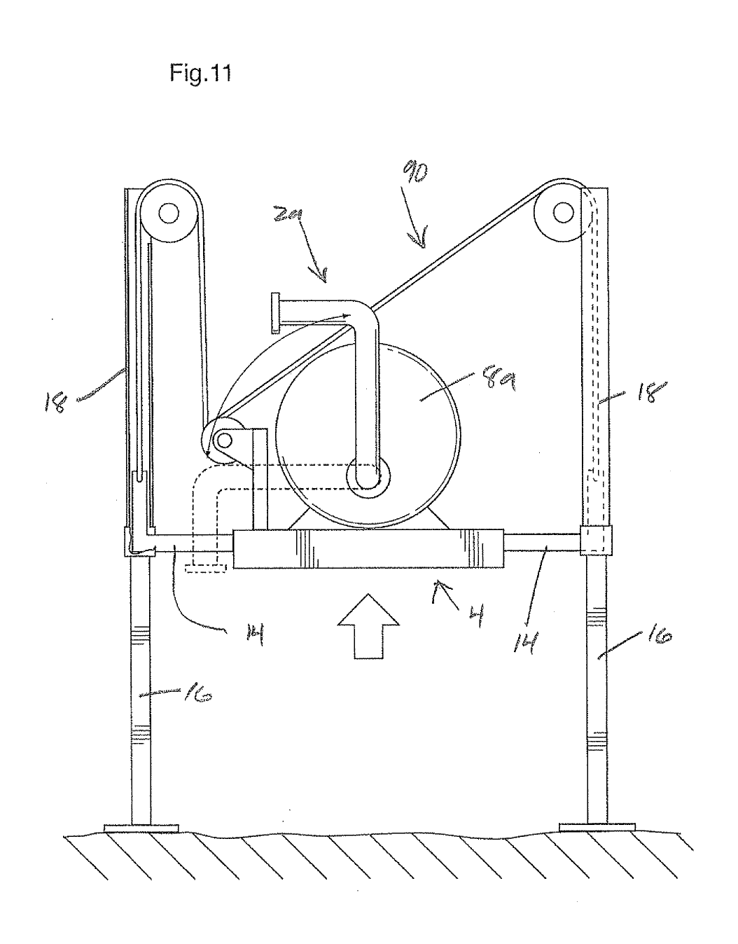

FIGS. 6 through 11 show the mobile loading transfer system adapted for unloading of tanker trucks and subsequent loading of spreading equipment. The mobile loading system 2a includes a structural frame 4 and wheels 6, however in this case the transfer tank 8 has been replaced with two vacuum type tanks 8a and 8b. The alternative arrangement is primarily associated with the transfer of the liquid manure from the tanker truck 40 to the system 2a and the subsequent transfer of the liquid manure from the mobile system 2a to farm spreading equipment generally shown as 100.

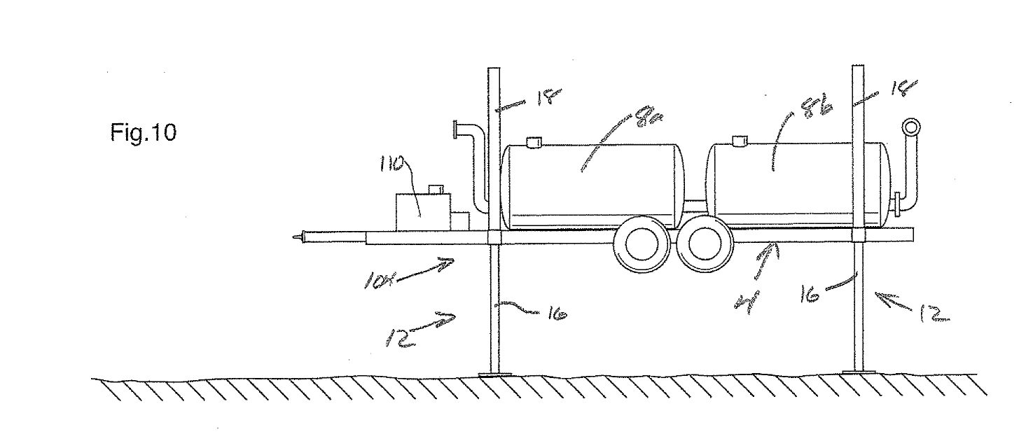

In contrast to the mobile system of FIG. 1, the alternative structure effectively cycles between a ground level position 102 (FIG. 6) for receiving of liquid manure from a tanker truck, to a raised position 104 (FIG. 10) for transfer of the liquid manure or sewage from the vacuum tanks to the spreading equipment. To allow this to occur quickly, the lifting arrangement of the alternative arrangement uses a cable lifting-type arrangement 90 as this can be more easily powered and allows faster raising and lowering of the system. Other lifting arrangements can be used including hydraulic lifting arrangements.

By using a vacuum tank system, the unloading time can be reduced due to pulling of the liquid manure into the tanks. In addition, by dropping the vacuum tanks to the ground level position 102, gravity assisted loading of the vacuum tanks is carried out. A substantial time savings is realized with respect to unloading of the tanker truck 40. Preferably the tanker truck can include a bottom discharge outlet for gravity loading of the vacuum tanks, however it can also be a top load and merely rely on the partial suction as well as gravity to assist in the unloading. A top unloading arm 108 is shown in FIG. 6 about to be inserted in the tank truck.

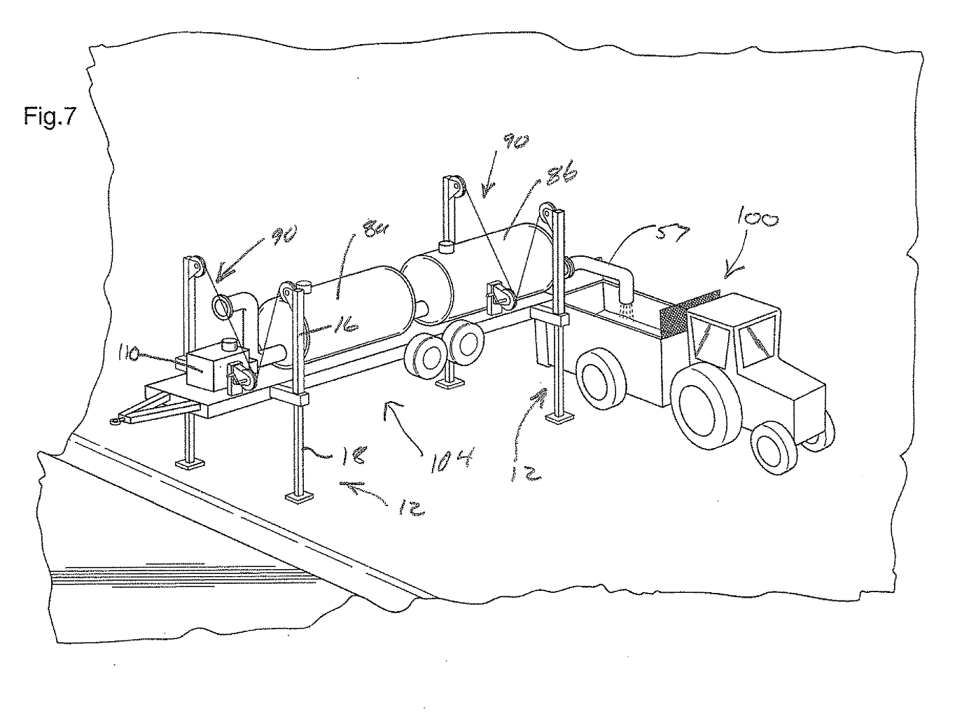

To effectively rapidly load the spreading equipment, the alternative arrangement 2a is lifted to the raised position 104 shown in FIGS. 7, 10 and 11. The vacuum tanks have been raised to a level to allow gravity assisted loading of the farm spreading equipment 100. In this way both the spreading equipment 100 and the tanker equipment 40 have increased utilization as the unloading time with respect to the tanker truck is reduced and the loading time with respect to the farm spreading equipment is reduced. The use of two supply vacuum tanks in the alternative system provides additional capacity and provides a vacuum assist. These tanks can be conventional tanks or a single conventional tank. Vacuum tanks are helpful where the site conditions are such that gravity loading of the farm equipment is difficult. Similarly, if gravity unloading of the tanker truck is not possible, vacuum tanks can reduce the unload time.

The cable lifting arrangements include a power drive 110.

The alternative mobile system in the raised position preferably has a discharge arm 57 at one end of the tank for loading of the farm spreading equipment. An opposite end of the tank includes a loading arm 108 used for unloading of the tanker truck.

The alternative arrangement can also provide advantages even where conventional tanks are used to provide gravity assistance in loading and unloading. The use of a vacuum tank or tanks is preferred for additional efficiencies.

The present arrangement has significant advantages over conventional equipment due to the more cost effective usage of the equipment, in particular more efficient loading of tanker trucks and the more effective off loading of the tanker truck. By providing a gravity assist loading of a tanker truck, the amount of foam that is produced during the loading is substantially reduced and thus the loads carried by the tanker truck are increased.

With this system the number of tanker trucks and operators required to run a continuous operation is reduced. The system is flexible as the number of pumps associated with the loading of the liquid manure from a lagoon or other source to a tanker truck is easily varied and if necessary a secondary mobile system can also be used. The system is mobile and thus an operator can arrive on site, set up and effectively transfer liquid manure at known rates and thus the system can be optimized with respect to both loading and unloading. This allows effective use of operators' time throughout the system including the spreading operation.

As can be appreciated, the system is easily transported from location to location and does not require extensive set up. To be effective it is important to be able to set up quickly, transfer the desired amount in a fairly compressed period of time, and then move on to the next job. The present system is significantly less expensive and more efficient than the previously used large vacuum trucks. The present mobile system has been described with respect to liquid manure applications but the system can also be used in other liquid transfer systems that require a temporary or seasonal usage.

A further arrangement is shown in FIG. 12. In this embodiment, a hydraulically driven concrete pump or pump capable of pumping solids is positioned in the lagoon and a diesel power drive is provided near the lagoon. Although a single pump is shown, multiple pumps can be used. With this further arrangement, sand or other small aggregate that tends to accumulate in lagoons can be removed. Sand is often used as bedding in dairy farm applications and makes it way to the lagoon.

By using concrete pumps relatively high volumes can be moved without damage to the equipment. With this arrangement the nurse tank is provided with an auger to avoid settling of the solids and transfer of the solids to the tanker truck. Gravity loading of the tanker truck from the nurse tank further assists in transfer of these solids.

The system of FIG. 12 can also be used for other applications where accumulation of solids in the treating of waste occurs. For example, in municipal treatment plants solids tend to accumulate and eventually require removal. The inlets to the concrete pumps can be controlled and moved across and along a settling bed to effectively remove accumulated solids without first empting of the bed. Agitators can also be used to assist transfer. In some applications it is desirable to use one or more electric pumps at the end of the boom. These electric pumps can be powered by a smaller capacity gas generator. The electric pumps are more energy efficient for removal of liquid manure having only a small amount of solids. The hydraulically driven concrete pumps require a higher capacity power source and in many cases the power take-off of a tractor is commonly used. The actual operating cost or even the running cost of a tractor is considerably higher than an appropriately sized power source. If an agitator is used, a higher capacity power source similar to the concrete pump requirements is used. By selecting the appropriate pump for the specific job application, a significant energy efficiency can be realized.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A mobile loading system used in transfer of liquid waste comprising a structural frame and at least a pair of wheels mounted to said structural frame;
a transfer tank mounted above said structural frame with said supply tank including a bottom outlet sized for high flow gravity unloading of said supply tank;
said structural frame including a lifting and support arrangement movable between a storage position with said wheels adjacent ground level to a raised operating position with said structural frame raised at least six feet above the position of said structural frame in said storage position.

2. A mobile loading system as claimed in claim 1 wherein said lifting and support arrangement includes at least 3 vertically extendible lifting members, said lifting members being laterally movable from said storage position adjacent said structural frame outwardly to said operating position;
said lifting members being extendible to engage a ground support surface and to subsequently raise said structural frame to said operating position.

3. A mobile loading system as claimed in claim 2 wherein said lifting and support arrangement includes 4 vertically extendible lifting members positioned in pairs at opposite ends of said supply tank.

4. A mobile loading system as claimed in claim 3 wherein said 4 vertically extendible lifting members are hydraulic cylinders.

5. A mobile loading system as claimed in claim 1 wherein said supply tank is a vacuum tank.

6. A mobile loading system as claimed in claim 5 wherein said vacuum tank includes a loading arm connected to said vacuum tank adjacent a bottom level of the vacuum tank, said loading arm including an on/off control valve for controlling discharge through said loading arm.

7. A mobile loading system as claimed in claim 5 wherein said lifting arrangement includes a drive arrangement for quickly raising said structural frame from a ground position for loading of said vacuum tank to said raised operating position for gravity assisted unloading of said vacuum tank.
